(19) United States
(12) Patent Application Publication
(10) Pub. No.: US 2005/0246395 A1
(43) Pub. Date: Nov. 3, 2005

(54) Databases synchronization

(75) Inventor: Jorge Abellan Sevilla, Paris (FR)

Correspondence Address: OSHA LIANG L.L.P., 1221 MCKINNEY STREET, SUITE 2800, HOUSTON, TX, 77010, US

(73) Assignee: AXALTO SA, Montrouge (FR)

(21) Appl. No.: 10/521,887

(22) PCT Filed: Jul. 11, 2003
(86) PCT No.: PCT/IB03/03216

§ 371 Date: Jan. 19, 2005

(30) Foreign Application Priority Data
Jul. 19, 2002 (EP) 02291843.7

(51) Int. Cl. G06F 12/00

(52) U.S. Cl. 707/204

(57) ABSTRACT

The invention deals with database synchronization. A first database is stored in a removable device for example a smartcard communicating with a first system. A second database of the same nature being stored in a second system communication with said first system. Said first and second system comprises means able to generate synchronization objects defining the last database synchronization which has been performed between said two databases of said two systems. After each synchronization step of the first database with the second database, a program external to the removable device sends a command to the removable device forsetting a synchronization object to said first database, said synchronization object being also affected to the second database which has been synchronized.

### FIELD OF THE INVENTION

The present invention relates generally to communications systems and, in particular, to techniques that provide for synchronizing databases. Synchronization is the act of establishing equivalence between two data collections, where each data item in one collection maps to a data item in the other one, and each item and its respective mapping having a content, which is the same, or equivalent or which corresponds to predefined requirements.

This invention particularly applies to removable devices, such as a SIM (Subscriber Identity Module) smartcard, that can be inserted into different terminals.

In the context of the invention, a database has to be understood as a data container (e.g. table, file . . . ). No presumptions about its structure are needed.

In the same manner, an item is a specific data of a database. (e.g. a record of a file, a row of a table, . . . )

### PRIOR ART

Synchronization protocols are used to synchronize the content of a database owned by a first system, generally a client, with the content of another database owned by a second system, which is generally a server. Both systems can be connected and can exchange messages (synchronization messages) using different transfer/session protocols (e.g. HTTP (HyperText Transfer Protocol), WSP (Wireless Session Protocol), . . . ).

The synchronization principles are basically the following:
Firstly, client and server systems arrange some initial synchronization parameters (e.g. which databases are going to be synchronized, type of synchronization . . . );
Secondly, one of them (the first system) sends the changes (additions, modifications, . . . ) which have occurred since the last time their databases were synchronized between themselves. These changes are often stored in a file called ChangeLog file. This ChangeLog file reflects all the modifications in particular the identity of the database record for which the event occurred and a timestamp indicating when the event took place.
Then, the second system processes the changeLog received (modifying its database if required), and sends its own changLog to the first system.
Following the changeLog received, the first system changes its database if required.
Then, both systems exchange acknowledges and other finalization messages if required, ending the synchronization process.

In the above process, the first system could be a mobile phone and the second system a personal assistant. Modifications may also occur in the SIM card coupled to the mobile phone. In this case, all the modifications, which occur in the SIM, are stored in the ChangeLog file included in the first system. Nevertheless, two important facts must be considered when trying to define a smartcard synchronization solution:
The smartcard is a removable device that can be inserted into different systems;
The content of the smartcard can be accessed and modified by different systems using different transport mode (by APDU (Application Protocol Data Unit) commands from the terminal, by Over The Air (OTA) commands, etc. . . . ).

These two facts have a clear initial consequence:
For synchronization purposes, the smartcard cannot be managed as a simple memory accessed by one system, because its memory is not attached or controlled by a unique system.
Moreover, due to the lack of resources (memory, processing or communication capabilities), the smartcard is not able to support a complete synchronization protocol. In particular, contrary to systems such as mobile phone or personal assistant, a smartcard has no clock for dating a modification of its content.

### THE INVENTION

The main purpose of the invention is to provide a smartcard which manages its own modifications, ensuring a synchronization between a database stored in the smartcard itself instead of using a copy or the corresponding ChangeLog stored in the mobile phone as in the prior art.

According to the invention, for databases synchronization purpose, a program external to the removable device sends a command to the removable device for setting a synchronization object to said first database, a synchronization object being affected to said first database, said synchronization object being also affected to the second database once the synchronization step between the two databases has been successfully performed, said object defining the last database synchronization which has been performed between said two databases.

In this way, a synchronization object is linked to a database in the smart card, and this synchronization object is set by an external program stored in a system outside the smartcard, this system having the necessary resources for performing a database synchronization. So that, with the invention, the smartcard can be inserted in any device, ensuring a synchronization of its databases, independently of the system which has modified its content.

It will be easier to understand the invention on reading the description below, given as an example and referring to the attached drawings.

In the drawings:

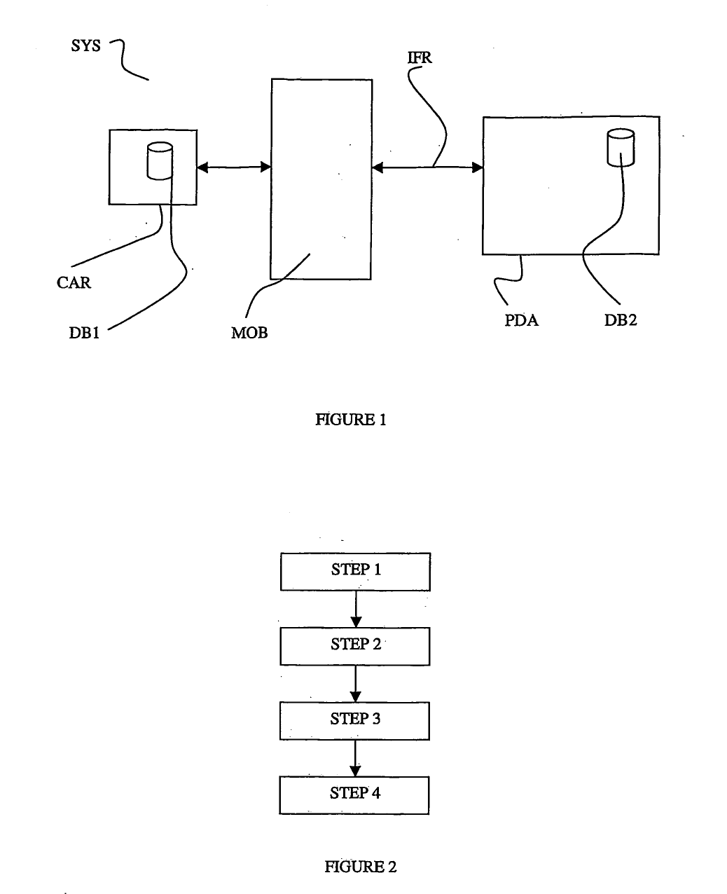

FIG. 1 is a schematic view a system in which the invention can be applied.

FIG. 2 is an algorithm illustrating the different steps of a practical example.

### DETAILED DESCRIPTION OF A PRACTICAL EXAMPLE

FIG. 1 is a schematic view of a system SYS including a SIM card CAR coupled to a mobile phone MOB. In our example, this system SYS also includes a digital assistant (PDA) communicating with the mobile by way of a network IFR. This network could be for example an infrared connection.

In our example, the card CAR stores a database DB1 and the assistant stores a database DB2. In another example, the second database could be stored in the smartcard CAR itself.

In our example, the mobile MOB, for example under user request, wants to synchronize the database DB1 with the assistant database DB2 both connected by the infrared port.

In our example, each database DB1 and DB2 is a file of the same nature. More particularly, the database DB1 to be synchronized is the user's phonebook contained in a file EF (Elementary File) of the user's card CAR.

Generally, the Mobile equipment MOB is able to interrogate the smartcard using APDU messages over the standard T=0 protocol. We will refer to this standard for more explanations about this protocol.

According to the invention, the smartcard supports synchronization object managing and modification detection. In our example, the mobile phone MOB having access to the smartcard has three commands to get and exploit the information related to synchronization objects and modification detection.

Synchronization objects will be linked to a database and represent a specific state of the database after a successful synchronization with a specific device.

In our example, there are three new commands fictitiously named NewSync, GetChanges, StoreSync. The functions of theses commands are explained below:

NewSync: With this command, the mobile MOB informs to the smartcard that a new synchronization of the data of one of its database DB1 with a second database (DB2) has to be performed. The smartcard answers with the identifier of the synchronization object affected to the database DB1, if exists, defining the last time that this database DB1 has been synchronized with the database DB2 (synchronization object is referred as “last synchronization object”). Preferably, It also proposes a new synchronization object defining the state of the database after this current synchronization (“new synchronization object”).

GetChanges: With this command, the mobile MOB asks for the modifications of the database DB1 which has occurred since the last synchronization object. The smartcard CARD answers with the identifiers of the database items modified, added or deleted. Preferably, only the identifiers are returned. So, if required, the mobile MOB could make use of its local copy of the smartcard memory to follow with the synchronization protocol.

StoreSync: With this command, the mobile MOB informs to the smartcard CAR that the synchronization has been performed. (Changes may have occurred in the smartcard following the synchronization protocol managed by the device).

The smartcard CAR will replace the last synchronization object by the new one, and will be henceforth able to detect further modifications in the database DB1.

With these three commands, the smartcard CAR will provide a set of actions required to perform a synchronization of data stored in the smartcard, considering the problems and restrictions defined before.

The different steps (steps 1 to step 4) illustrating the invention will give a better understanding of the invention.

Step 1

Before starting the synchronization protocol, the mobile MOB sends to the smartcard CAR the NewSync command with the identifier of the PDA and the name or identifier of the file DB1 to be synchronized. The smartcard remembers that a previous synchronization with the same PDA has been performed some times ago, with a synchronization object named “04012002131412”. In our example, the card sends back the last synchronization object identifier and proposes a new synchronization object identifier “05022002131412”.

Step 2

At this time, the mobile MOB starts a synchronization process with the assistant using one of the available synchronization protocols. The mobile MOB is able to initiate data synchronization with the PDA by the corresponding exchange of initialization messages.

The last synchronization object provided by the smartcard CAR can be used in the synchronization protocol to be compared with the last synchronization object stored in the PDA:
If synchronization objects do not match (or any of them does not exist), a full synchronization is requested by the synchronization protocol. It means that both devices must exchange all the data (of the ADN file). In this case no usage of modification register is needed. All the database content is supposed to have been modified (added). In this case, the mobile sends a command [SLB3]to the card (CAR) for setting a synchronization object to said first database (DB1), said synchronization object being also affected to the second database (DB2) which content has been synchronized with database (DB1). Then, in this case, the synchronization process is finished. The setting step is a configuration step in which the generation of a synchronization object is requested.
If the two last synchronization objects match, it means that a successful synchronization was performed in the past, and that both devices may exchange only modifications occurred since this last synchronization. In this case, the following step is Step 3.

Step 3

The mobile equipment may interrogate the smartcard to know about the changes occurred since the moment when the last object was set. It sends a GetChanges command, and the smartcard answers with the list of the modifications (e.g. “Added record 1 and 2, modified record 4, deleted record 7”). The mobile equipment MOB may then perform following commands to know what has been the result of the modifications. For instance, it can read the record 4 to see its value (maybe not if it has it in a local copy).

In this step, the mobile MOB and the assistant exchange their modifications following the used synchronization protocol.

Once it has all data need it can continue the synchronization protocol sending the following messages with the client modifications and eventually receiving and performing the server modifications.

Step 4

Once the synchronization protocol is finished, the mobile MOB shall send a StoreSync command to the smartcard, to set the new synchronization object. Once this command is performed, the smartcard will be able to detect changes henceforward performed.

The smartcard stores the active synchronization object as the last synchronization object for future synchronization with the same PDA. Hereafter, the smartcard will be able to detect changes performed after this moment following commands in future synchronization.

Some additional comments can be added to this example:
If we insert the smartcard into another mobile MOB and we try to synchronize again with the same PDA, synchronization can be performed because change detection and synchronization objects management are independent from the system in which is inserted the smartcard.
Advantageously, synchronization of both devices can be performed in any protocol supported by them because, the 3 commands included in the synchronization procedure preferably does not force any specific requirement to the synchronization protocol.
Any other device having access to the smartcard and to the three new synchronization commands as illustrated in our example can substitute the mobile. (e.g. OTA server);
The methods defined can also be used to synchronize smartcard data with the local copy of the smartcard data in the mobile equipment. This is a local synchronization between the smartcard and the mobile equipment.

Generally, the invention provides some interesting features.

In our illustrated invention, we have seen that, for databases synchronization purpose, an external program reads the synchronization object in the removable device and compares it with the synchronization object affected to the second database, compares them, and function of this result, synchronizes data in the databases. The external program can be located in the mobile phone or in another system communicating with this mobile phone. So that, when a synchronization process has to be performed in the future between a first and a second databases (DB1,DB2), the synchronization object is used because defining the last database synchronization which has been performed between said two databases (DB1,DB2),

We have also seen that, for initiating a synchronization step, the first system (MOB) informs to the removable device CAR that a new synchronization of the data of one of its databases with another system (PDA) is to be performed, then the removable device CAR answers with the current synchronization object, if exists, defines the last time that this database has been synchronized with this system PDA, and also proposes a new synchronization object, for future use, defining the state of the database after the current synchronization. The old and the new synchronization object can be sent in a same message or in two different messages.

We have also seen that when the first device MOB asks for the modifications of the database, which have occurred since the last synchronization object, the removable device answers with the identifiers of the database items modified, added or deleted. Preferably, only the identifiers of the database items are returned, the device MOB being able to make use of its local copy of the removable device CAR memory to obtain the database content and to follow with the data synchronization process.

We have also seen that the device MOB preferably informs to the removable device MOB that the synchronization has been performed. The removable device replaces the last synchronization object by the new one, this new synchronization object being able to detect further modifications since the last synchronization.

Preferably, the mobile MOB sends, for information, a command to the removable device with the identifier of the device and the name of the database to be synchronized.

The invention also deals with a removable device, in particular a smart card CAR. After each synchronization step of said database DB1 with said second database DB2, the smart card receives a command initiated by an external device requesting to set a synchronization object to said first database DB1, said synchronization object being also affected to an outside second database (DB2) which content has been synchronized with database DB1.

The invention also deals with a system MOB able to communicate with a removable device CAR. This system comprises a program for sending, when synchronization between the two databases (DB1,DB2) has been performed, a command to said removable device CAR for setting a new synchronization object, said new synchronization object being also affected to the second database DB2 which content has been synchronized with database DB1.

We see now that the invention offers many advantages. The invention provides a method to manage its modifications and interfaces to access to these methods whatever the entity accessing to the smartcard is. In easier words, the smartcard performs some required actions to be integrated in the synchronization process. So that, the smartcard is able to support a complete synchronization protocol.

1. A method for synchronizing data stored in two different databases of the same nature, at least one of the two databases being stored in a removable device, in particular a smartcard, said removable device communicating with a system, characterized in that, for databases synchronization purpose, a program external to said removable device sends a command to the removable device for setting a synchronization object to said first database, a synchronization object being affected to said first database, said synchronization objecting being also affected to the second database once the synchronization step between the two databases has been successfully performed, said object defining the last database synchronization which has been performed between said two databases.

2. The method according to claim 1, characterized in that it comprises, when a later synchronization process has to be performed between the first and the second databases, the step of reading the synchronization object affected to the first database and compares it with the synchronization object affected to the second database, and if the objects matches, each of the records that was modified from one of the databases is modified in the other database.

3. The method according to claim 2, characterized in that it comprises, when a system initiates a synchronization step, the step of informing to the removable device that a new synchronization of the data of the first database with said second database, then the removable device answers with the current synchronization object, if exists, defines the last time that this database has been synchronized with this second database, and also proposes a new synchronization object, for future use, defining the state of the database after the current synchronization is finished.

4. The method according to claim 1, characterized in that the external program asks for the modifications of the first database, which has occurred since the last synchronization object, and the removable device answers with the identifiers of the database items modified, added or deleted.

5. The method according to claim 4, characterized in that the device is able to make use of a local copy of the removable device memory to obtain the database content and to follow with the data synchronization process.

6. The method according to claim 1, characterized in that the device informs to the removable device that the synchronization has been successfully performed, the removable device replacing the last synchronization object by the new one, this new synchronization object being able to detect further modifications since the current synchronization.

7. The method according to claim 1, characterized in that the synchronization object is a random number generated in the removable device.

8. A removable device, in particular a smart card, being able to communicate with a system, said removable device including a first database able to be synchronized with a second database of the same nature, characterized in that it comprises means for, when a synchronization step is initiated between said two databases, receiving a command initiated by an external system requesting to set a synchronization object to said first database, a synchronization object being affected to said first database, said synchronization object being also affected to the second database once the synchronization step between the two databases has been successfully performed, said object defining the last database synchronization which has been performed between said two databases.

9. A system able to communicate with a removable device, in particular a smart card, said removable device including a first database to be synchronized with a second database of the same nature, characterized in that it comprises a program for setting each time a synchronization step is initiated between said two databases, a synchronization object to said database for affecting a synchronization object to said first database, this synchronization object being also affected to said second database once the synchronization step between the two databases has been successfully performed, said object defining the last database synchronization which has been performed between said two databases of said two system.

10. A computer program product for system able to communicate with a removable device, said removable device storing a first database to be synchronized with a second database, the computer program product including an instruction set which when the instruction set is loaded in the system, makes the system perform, when a synchronization is initiated between said first database and said second database, a setting step in which a command is send to said removable device for setting a synchronization object to said first database, a synchronization object being affected to said first database, said synchronization object being also affected to the second database once the synchronization step between the two databases has been successfully performed, said object defining the last database synchronization which has been performed between said two databases and being used for future synchronization step between these two databases.

11. A computer program product for a removable device able to communicate with a system, said removable device storing a first database to be synchronized with a second database, the computer program product including an instruction set which when the instruction set is loaded in the system, makes the removable device, when a synchronization is initiated between said first database and said second database,
A receiving step in which the removable device receives a command coming from an external system, said command having the function of setting a synchronization object,
An execution step in which said program executes the command in setting the generation of a synchronization object to be affected to said first database, said synchronization object being also affected to the second database once the synchronization step between the two databases has been successfully performed, said object defining the last database synchronization which has been performed between said two databases.

12. The program according to claim 11, characterized in that the synchronization object includes a random number.

13. The method according to claim 3, characterized in that the device informs to the removable device that the synchronization has been successfully performed, the removable device replacing the last synchronization object by the new one, this new synchronization object being able to detect further modifications since the current synchronization.
